(19) United States
(12) Patent Application Publication
(10) Pub. No.: US 2023/0062728 A1
(43) Pub. Date: Mar. 2, 2023

(54) PRIVACY ECOSYSTEM ENVIRONMENTAL IMPACT MONITORING

(71) Applicant: ALLSTATE INSURANCE COMPANY, Northbrook, IL (US)

(72) Inventors: Timothy GIBSON, Barrington, IL (US); Marvin LU, Chicago, IL (US); Thomas J. WILSON, Chicago, IL (US); Aleksandr LIKHTERMAN, Wheeling, IL (US); Raja THIRUVATHURU, Aurora, IL (US); Deepak RAJ, Carol Stream, IL (US)

(21) Appl. No.: 17/863,046

(22) Filed: Jul. 12, 2022

Related U.S. Application Data
(63) Continuation-in-part of application No. 17/587,799, filed on Jan. 28, 2022.
Application No. 17/587,799 is a continuation-in-part of application No. 17/587,815, filed on Jan. 28, 2022.
(60) Provisional application No. 63/239,215, filed on Aug. 31, 2021.
(60) Provisional application No. 63/239,215, filed on Aug. 31, 2021.
(60) Provisional application No. 63/239,215, filed on Aug. 31, 2021.

(51) Int. Cl. G06Q 30/02; G06Q 30/00

(52) U.S. Cl. CPC G06Q 30/0208; G06Q 30/0204; G06Q 30/018

(57) ABSTRACT

A system collects ongoing user activity information relating to a predefined activity, using one or more devices having a predefined relationship to a user and determines an environmental impact value of the predefined activity based on environmental impact caused by one or more aspects of the predefined activity. The system determines at least one change to the predefined activity that would achieve a diminished environmental impact, suggests the change to the user via a device interface and, responsive to acceptance of the change, implements a control strategy to assist the user in achieving the change.

### CROSS-REFERENCE TO RELATED APPLICATIONS

This application claims the benefit of U.S. provisional application Ser. No. 63/239,215 filed Aug. 31, 2021, the disclosure of which is hereby incorporated in its entirety by reference herein and is a Continuation-in-Part of U.S. application Ser. No. 17/587,799, filed on Jan. 28, 2022, which claims the benefit of U.S. provisional application Ser. No. 63/239,215 filed Aug. 31, 2021, and is a Continuation-in-Part of U.S. application Ser. No. 17/587,815, filed on Jan. 28, 2022, which claims the benefit of U.S. provisional application Ser. No. 63/239,215 filed Aug. 31, 2021, the contents of each of which are also incorporated in their entirety by reference herein.

### TECHNICAL FIELD

The illustrative embodiments generally relate to determinations of, and strategies to improve environmental impact achievable in conjunction with, among other things, a privacy ecosystem.

### BACKGROUND

Many attempts are being made to mitigate the environmental impact of various aspects of life. Vehicles are utilizing electric power, infrastructure is beginning to include wind and solar power, companies are cutting back on waste and attempting to use packaging that minimizes impact, etc. One way of looking at the impact of an action or situation is to contemplate the “carbon footprint” of the action or situation.

Carbon footprint may refer to the amount of greenhouse gasses caused by people or companies, and can include the production of such gasses that are emitted through the burning of fossil fuels, consumption or use of goods or products, transportation usage, etc. Even a single day of activity for an average person may include hundreds, if not thousands, of carbon-producing activities, if one includes the activities that resulted in the goods and services utilized, as well as direct carbon production. This makes contemplating a true carbon footprint a very difficult task.

Further, every person may create or contribute to the creation of carbon and other gasses in a very different manner, making it difficult to find a one-size-fits-all strategy for carbon reduction. Someone who avoids using a vehicle may have a very good environmental impact from a straight carbon production perspective, but that same person may engage in shopping habits that contribute to significant carbon usage based on packaging usage and inefficient purchasing, resulting in large quantities of excess shipping packaging and shipping mileage. Someone else may eat a great deal of single serving food, resulting in excessive travel and packaging on a per-meal basis.

The process gets even more complicated if one considers root-sourcing for all elements of analysis, for example, a meal can include carbon from packaging, carbon from production of both cooking the meal and production of the ingredients, a share of the carbon generated by the restaurant operation, carbon for travel of the food or diner to and from the restaurant, etc. A person eating a salad by walking downstairs to a restaurant with a garden in an apartment building may generate significantly different carbon from a person who lives 20 miles from a restaurant ordering a salad to be delivered, especially if that second salad is also sourced from sources far afield. This also makes it difficult to contemplate the carbon impact of even a relatively minute activity.

Because of the complexity of the data, among other things, and a general lack of knowledge about what specific activities a given person is engaged in, it can be very difficult to calculate personal carbon footprint, let alone analyze behavior and find out what activities a given individual could change to best mitigate their personal footprint.

### SUMMARY

In a first illustrative embodiment, a system includes one or more processors configured to collect ongoing user activity information relating to a predefined activity, using one or more devices having a predefined relationship to a user and determine an environmental impact value of the predefined activity based on environmental impact caused by one or more aspects of the predefined activity. The one or more processors are further configured to determine at least one change to the predefined activity that would achieve a diminished environmental impact. The one or more processors are also configured to suggest the change to the user via a device interface and responsive to acceptance of the change, implement a control strategy to assist the user in achieving the change.

In another embodiment, the the devices include a home appliance. In still a further embodiment the predefined activity includes usage of the home appliance. In an additional embodiment the devices include a mobile personal device. In an additional embodiment the predefined activity includes travel achieved while possessing the mobile personal device.

In a further embodiment, the one or more processors are further configured to determine a mode of travel based on travel characteristic information collected from the mobile personal device and determine the environmental impact based at least in part on the mode of travel.

In yet another embodiment the devices include a vehicle. In an additional embodiment, the predefined activity includes travel using the vehicle. In a further additional embodiment, the impact includes at least a fixed impact associated with one or more devices involved in the predefined activity.

In yet another embodiment, the change is determined based at least in part on user-defined parameters exempting specified changes and the change accommodates to the parameters so as not to utilize an exempted change. In another embodiment the predefined activity includes at least a device with changeable settings and the control strategy controls the device settings in accordance with the change as suggested to the user, to automatically change a functioning of the device to achieve the diminished environmental impact.

In a further embodiment the control strategy includes delivery of one or more reminders to a user based on engagement in the predefined activity. The one or more processors are further configured to determine, based on information collected from at least the mobile personal device, that the user is engaging in the predefined activity and, responsive to determining that the user is engaging in the predefined activity, deliver a reminder to the mobile personal device to change an aspect of the predefined activity in accordance with the at least one change. In another embodiment, the one or more processors are further configured to determine that the user is engaging in the predefined activity in a manner not in accordance with the at least one change, based on information collected from the at least one mobile personal device and wherein the delivery of the reminder is further responsive to the determination that the user is engaging in the predefined activity in the manner not in accordance with the at least one change.

In another illustrative embodiment, a system includes one or more processors configured to determine that a user is engaging in a predefined activity based on data collected from at least one computing device and determine a context demographic for the predefined activity, based on context having a predefined correlation to the predefined activity and values associated with the context gathered responsive to the determination that the user is engaging in the predefined activity. The one or more processors are further configured to determine a baseline environmental impact associated with the activity, defining an average environmental impact for the activity based at least in part on the values associated with the context and determine an actual environmental impact of the predefined activity as achieved by the user. Also, the one or more processors are configured to assign a positive or negative value of environmental impact credits to a user digital wallet, based on a difference between the actual environmental impact and the baseline environmental impact.

In an additional illustrative embodiment, the one or more processors are further configured to determine at least one aspect of the predefined activity that can be changed to improve the actual environmental impact and a recommended change to the at least one aspect to improve the actual environmental impact, suggest the change via a device display, and implement a control strategy to automatically achieve the change, responsive to user acceptance of the change.

In still a further embodiment the predefined activity includes usage of a configurable home appliance and wherein the control strategy includes reconfiguration of the home appliance in accordance with the change. In an additional embodiment, the predefined activity includes purchase of a good, and the one or more processors are configured to determine that the user intends to purchase the good based at least on placement of the good in a digital shopping cart. The control strategy includes recommending an alternative good having a lower environmental impact associated therewith, the alternative good being identified by the change.

In a further illustrative embodiment, a method includes determining an aggregate environmental impact of a plurality of user activities to form an environmental impact profile for the user, the aggregate environmental impact determined based on data gathered from user devices and indicating user behavior related to the user activities that generate an environmental impact. The method also includes determining at least one change to an activity that would result in diminished environmental impact from that change. Further, the method includes presenting a strategy including the at least one change to the user via a device display and implementing a control strategy to automatically enact the at least one change responsive to user acceptance of the strategy.

In another embodiment, the activities include at least home appliance usage and the control strategy includes automatic reconfiguration of a home appliance to change a usage characteristic in accordance with the at least one change. In yet another embodiment, the impact reduction strategy includes the control strategy and at least one other strategy.

### BRIEF DESCRIPTION OF THE DRAWINGS

FIG. 1A shows an illustrative example of non-limiting types of data that could be gathered in a personal data vault;

FIG. 1B shows an illustrative example of database sets that can be compiled and used for impact analysis;

FIG. 2 shows an illustrative example of an analysis framework and outputs;

FIG. 3 shows an illustrative process for strategy application, automation and adherence tracking;

FIG. 4 shows an illustrative example of a tracking process in more detail;

FIG. 5 shows an illustrative example for user tuning of demographics and goals for display and strategy selection; and

FIG. 6 shows an illustrative example of a process for impact credit mining.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a first mobile, personal or cloud computing system, in certain embodiments, the exemplary processes may be executed by a second computing system in communication with the first computing system. Either system may include, but is not limited to, a wireless device (e.g., and without limitation, a mobile phone) or a remote computing system (e.g., and without limitation, a server) connected through the wireless device. In certain embodiments, particular components of either system (or additional systems) may perform particular portions of a process depending on the particular implementation of an embodiment or an implementation similar to an embodiment. By way of example and not limitation, if a process has a step of sending or receiving information in conjunction with a wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication, and other suitable wireless and wired communication usable for both short range and long-range wireless transmission as appropriate for a given implementation.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety and are understood to be examples of types of processes that may be performed to achieve elements of the invention. Additional steps may be added or removed from the exemplary processes as desired and the examples are intended to illustrate, but not limit, aspects of the proposed embodiments and inventive concepts.

With respect to the illustrative embodiments described in the figures showing illustrative process flows, it is noted that a general-purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments and the like propose methods and apparatuses for calculating personal carbon and environmental impact, analyzing root causes for the impact, providing customized and personal strategies for mitigating impact and generally improving both the knowledge about an individual's impact as well as the ability to change that impact.

Some aspects of the illustrative embodiments utilize personal data vaults (PDVs), described in greater detail in co-pending and co-owned U.S. application Ser. No. 17/587,799, filed on Jan. 28, 2022, and co-owned U.S. application Ser. No. 17/587,815, filed on Jan. 28, 2022, the contents of which are incorporated herein by reference in their entirety. That application describes, among other things, a personal data vault that incorporates a vast array of user footprint data, which can include, but is not limited to, travel habits, purchase habits, resource usage habits, etc. As opposed to disparate and sometimes duplicative sources of data that all need to be aggregated to analyze a person's net behavior, this personal data vault may provide a much more comprehensive viewpoint of an individual and allow for a more accurate and in-depth analysis of behavior that creates environmental impact, as well as behavior that can be changed. Further, when behavior is observed over a large number of such vaults, conclusions about the efficacy of behavioral changes can drawn and that knowledge can be used to bolster both suggestions about changes and more useful suggestions about changes. For example, it may be observed that while a change in several degree of heating in the winter is a good way to decrease carbon output, a certain area or demographic within an area, such as an area experiencing very cold winters, may not actually adhere well to such suggestions, preferring instead to remain comfortable, and another suggestion that may have a lesser impact may have a greater effect, being more likely to be followed.

Through the use of databases that provide comprehensive analysis on the environmental impact of specific activities, as well as background gathering of information about a person's entire day, with permission of that person, a much more accurate impact analysis can be performed than ever was historically possible. This leads to opportunities to change individual behavior in highly targeted manners, as well as opportunities to incentivize specific behaviors and to target incentives to behavioral changes that might be more likely to be adopted by a given locality or demographic. Further, because the division of demographics can be much more comprehensive with such data, it can be possible to identify impact-mitigating behavior likely to be followed by very specific groups of people (e.g., instead of “people aged 21-25,” the demographic might be “people within 10 miles of a major city center, aged 21-25, who use public transportation at least 5 times a week, who live in apartments, who watch 10 or more hours of streaming content a week, and who make at least 75% of their purchases online and who own at least two TVs”). While no one is defined by their peers, there are commonalities to behavior within groups and, moreover, when the demographic is wide, conclusions may often be inapplicable. An incentive to use less television (and thus less power) may be meaningless to the 5 percent of a demographic who uses no television to begin with, and so better clustering of people can lead to broader participation when the net goal is something like “diminish environmental impact,” where there is virtually no one who could not contribute by changing at least some aspect of behavior.

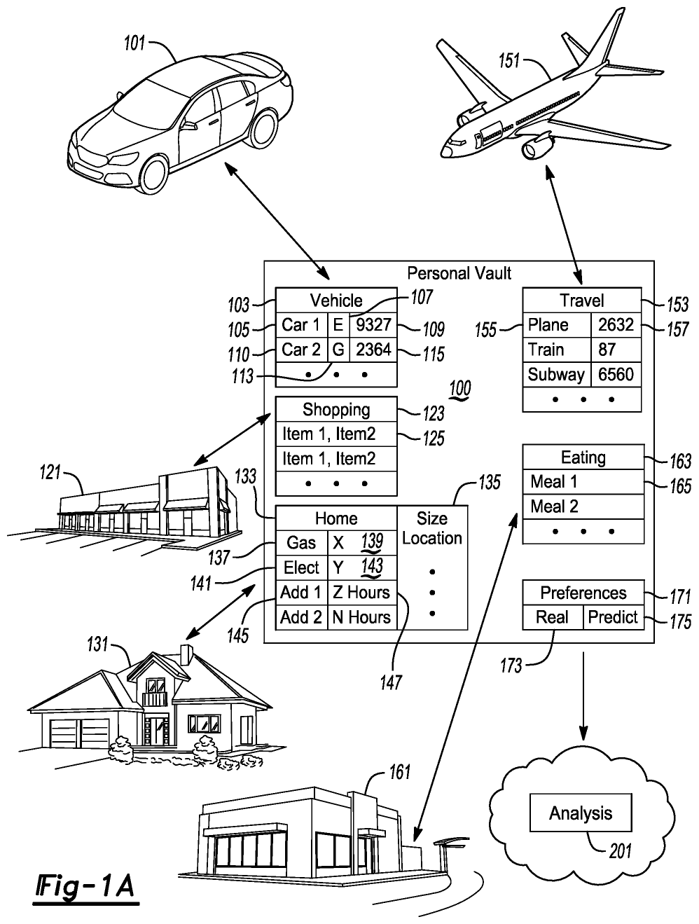

FIG. 1A shows an illustrative example of non-limiting types of data that could be gathered in a personal data vault 100. This data includes a variety of environmentally impacting activities, and in storage it can include both the nature of the activity and an amount of engagement. Additional data about the impact of such activity can be appended or cross-referenced from databases that correlate activities to specific impact. That is, to use the salad example from above, it may be possible to reasonable distinguish the two salad scenarios in a way that correctly assigns the impact value (or more closely assigns the impact value) to each user, so that instead of “eating a salad” having an average of X impact, it may be determinable that eating a salad from the downstairs garden restaurant has 0.1X impact and the person who has the salad delivered 20 miles from a chain restaurant has 9X impact. Thus, it would be appropriate to suggest that the second person could significantly change the impact by ordering from a closer location or buying the makings for salad in larger quantities and making one at home, whereas the first person may actually increase impact by shopping for salad makings if they had to travel in a vehicle to the store and the store sourced those makings from across the country. This reveals why “make your own salad” is not only necessarily the simple solution, it may actually be the wrong solution unless context is more closely contemplated, and context may be far easier to contemplate with a comprehensive and personally-specific data set.

In this example, vehicular travel 101 may reflect usage of both personal and public vehicles and transportation, and may include rideshares, busses, subways, trains, etc. This data may be combined with other travel data 151 or be separated into “regular” travel and leisure travel. The example shown separates personal vehicular travel (e.g., one's own car) from mass transit, and ridesharing could be placed in either category as deemed appropriate. A given user could even choose to classify the data one way or another, based on how it fit their own understanding, because the analysis may simply consider the net impact of such travel and render categorization less meaningful. A displayed mapping of environmental impact may quantify such data en masse, and it may be useful for the viewing user to understand what the sources of data include, but a suggestion to “use more ridesharing as opposed to personally driving a vehicle” is not dependent on how one classifies the data.

Here, the personal vehicular travel 101 is stored under vehicle categories 103, which may include, for example, vehicle types (e.g., make and model) 105, 111, fuel types (E=electric, G=gasoline, etc.) 107, 113, and miles traveled 109, 115. To the extent possible, based on given vehicle technology and other technology, it may also be possible to quantify the number of other occupants, for example, and so a trip of 100 miles may be alternatively recorded as a trip of 25 miles, if 3 other people were discernably present, or at least such presence data could be recorded. This could be pertinent because telling each of those 4 people to use individual rideshares could be a worse suggestion than having them travel together, and it may also be the case that personal carbon output should be considered as an apportionment of any group experiences—e.g., something shipped on a boat with 150,000 other items should receive an apportionment of the shipping impact, perhaps relative to its own weight or other reasonable factor, as well as contemplating the massive weight of the shipping vessel itself.

Decisions about how to specifically allocate apportioned impact are not necessarily the focus of this patent application, the underlying point is that with sufficient data about specific activities, usages, products, etc. for a specific person, generalizations can be avoided and a more true model of impact can be achieved. Apportionment may be relevant at least to the extent of how data is recorded, however, and whether any apportionment data is similarly recorded. For example, a BLUETOOTH device may be able to detect the BLUETOOTH signatures of proximate devices, and so if any number of devices traveled more than a few hundred feet in a short period of time and remained detectable to each other, they are all presumably in the same transportation unit. If a reasonable assumption of a one-person one-device is made (reasonable in many circumstances presently, at least), a guess can be made as to how the impact should be apportioned. So, for a given user, it may be worthwhile to record the number of detected devices or other proxy for co-occupants, if a true count cannot be obtained, in order to share the responsibility for impact more accurately and to allow for better suggestions on impact mitigation.

Any reasonable data about the net impact of a vehicle can be stored, such as types of fuel actually used, speeds of driving (aggressive driving using more carbon than defensive driving), aggressiveness of braking (and the impact of an Nth usage of a brake pad, for example, per stop), etc. Highway vs. surface road usage, travel during high-traffic, etc. All of this can be recorded with regards to each personal vehicle and apportioned as suggested, and all of this may be pertinent to determining net impact of the activity of vehicular travel.

Shopping activity 121 may also be recorded, as evidenced through personal device tracking (where a device travels) and copies of receipts stored from personal purchases. It is worth noting that the granularity of data being gathered may seem almost invasive to people, but the notion of a personally controlled privacy vault, where the owner can specifically control what is shared with anyone other than the owner, makes it far more reasonable to gather such data at this granular of a level, because if any fears of the data being shared are assuaged, many people would happily allow such data to be gathered on their own behalf, given all the personal benefits that can be achieved from analysis of one's own personal data.

In this example, recordation of shopping 123 may include a list of items purchased 125 on each trip, which may have carbon data for each item appended thereto, or be cross referenceable with databases that store specific carbon values for items. The distance traveled, type of transportation (or delivery) service, etc., may also be stored with regards to each trip, and the impact of travel can be apportioned between the items or shared in another manner. Thus, two people who consume exactly the same amount of food, and who live exactly the same amount distance from the same store may have very different values, if one of them shops daily using a personal gas vehicle and if the other shops weekly and rides a bicycle to the store. But, if the database lacked information about the transportation usage, then a conclusion that they have a similar consumption impact may be drawn, albeit incorrectly. Again, by having access to a wide variety of data about the whole process of obtainment through usage and potentially through disposal, a more accurate picture can be obtained, and a suggestion to shop in “bulk” may be reasonable for one party and not another. As more data becomes gatherable, more sophistication can be applied to the analysis and more precise results can be obtained.

Home activities 131 may represent yet another category of data, which might include home data 133 such as, for example, a fixed set of data 135 about the house (sq footage, location, material construction, insulation levels, etc.). This data may allow for better analysis about reasonable suggestions—a person in an under-insulated house in a cold climate may best decrease impact by increasing insulation, as opposed to turning down a thermostat, which they may not even be willing to do because of heat loss. This information can also allow for targeted home-based suggestions that are reasonable based on localities, and the data on many of these factors should rarely change barring an improvement to insulation, a home addition or a siding upgrade.

Impact factors within the home may include, for example, gas 137 usage 139, which could be usage per day, week, month, season, or generally any reasonable time period (day v. night, etc.) and can be represented as a net usage over a time period divisible by a smaller time period as well as a tracked periodic usage in case a day v. night analysis is desired. This information could be obtained from a gas provider, a user device, a digital bill, etc. Many gas and electric providers have installed digital meters and can very closely track usage and may be willing to allow a user to store this data in a personal vault. Similar to gas, electric 141 usage 143 may be tracked as well, including sources for power if any onsite (solar, wind, geothermal, etc.) sources of power exist.

As many appliances are “smart” appliances, those appliances 141, 145 and their usages 143, 147 can also be tracked. For more sophisticated appliances, settings such as load size (laundry), heat levels (dryer), dry cycle usage (dishwasher) etc. may also be tracked, to provide opportunities to identify which changes can be made to usage habits to achieve similar results (e.g., dry dishes) through less impactful activity (e.g., letting the dishes air-dry). Also, users may not be aware of energy saving settings and the impact of various setting usages from each appliance, and so a user may not think about the fact that overwashing/overdrying clothes or heat-drying dishes may have a significant impact when it occurs on a weekly or even daily basis.

Mass transit 151 habits may be another source of impact, in terms of apportioned impact, choices of transit, etc. Some of this data 153 may reveal “beneficial” travel habits, and may (as much of the data may) serve as a reasonable way to sort groups of people for recommendation purposes. This data can include, for example, types of travel 155, miles traveled per type 157, etc. More granular data may include flight or train occupancy (which may have to be estimated for security reasons, but may be approximately discernable based on a type of aircraft or train and a time of day or day of week). Care may be taken in apportioning certain data to users—a person flying on a nearly empty airplane may have their personal statistics thrown wildly askew if assigned 0.1 of the impact of a 200 person plane simply because the plane was mostly empty. For instances where the decision to travel was not the impetus for the vehicle traveling (e.g., the flight probably would have flown completely empty if needed at the next destination), and a subway train will always travel from the next-to-last stop to the last stop, even if empty, because it has to reach each stop, it may be more reasonable to assign a defined cost associated with the route and choice to fly or ride the subway. That said, observation of, for example, airline data, may reveal that if few enough people consistently fly a flight, the airline will change the route. Thus, encouraging fifteen or twenty people, who take regular, lightly-occupied flights from A to B, to change their travel habits to a more popular travel time may actually allow those people to make a significant impact by “forcing” the airline to change a route if enough of those people refuse to fly the lightly-occupied flight. The airline may even prefer this, but feel obligated to provide the certain flight as long as at least 15 people, for example, continue to regularly utilize it.

Food consumption habits 161 may also be tracked as consumption data 163. This can include, for example, any meals away from home or ordered for delivery, and may be considered separately from or in conjunction with grocery buying habits. Since any food not prepared at home has some amount of impact associated therewith (preparation, sourcing, travel of the person to the food or the food to the person, restaurant daily impact from lights, water, power, etc.), it may be reasonable to consider far more than the food itself when considering the impact. Delivery may be less impactful than pickup or dine-in in many cases, since it is effectively ride-sharing for food. Which restaurants are chosen, which foods are consumed, durations of stay, distances of travel, etc., all may have an effect on impact, and all this data can be tracked and recorded with respect to an individual consumer of the food. While it may not be possible to know the vehicle in which food was delivered, it may be reasonable to assign values to most other aspects of the process.

Data granularity is likely an impediment to obtaining a literally accurate value of carbon—two restaurants from the same chain may have a very different impact from obtaining an orange, for example, if one resides in an orange producing state and the other is 2,000 miles away from the nearest-grown orange. Moreover, it is unlikely all oranges, even for a single restaurant, let alone a single region, are consistently sourced in exactly the same manner from exactly the same source, so it may be reasonable to assign certain numbers based on regional or demographic observations (e.g., restaurants in a certain locality, restaurants using organic oranges, etc.). In a similar manner, other data may have to be modified to reflect reasonable averages, but it should be appreciated that the degree of granularity proposed is much more useful than, for example, assigning the same impact of an orange to every source (restaurant, grocery store, road-side stand, etc.) in the entire country. So while it may be virtually impossible to tell someone the impact of eating “that specific orange,” it may be possible to give a very close approximation of the impact of eating “an organic California orange obtained in Chicago, Ill.”

In conjunction with all of the personal data contained in the vault 100, personal impact preferences 171 may also be stored. This information can include, for example, certain preferences or necessities of a person's life that are not likely to change or change overmuch. Some people may have a necessary means of travel, but may be very interested in shopping habit changes that can diminish impact. Other people may be unwilling to change shopping habits, but may happily modify home energy usage routines.

Data may also reflect real impact 173 (to the degree that it can be determined based on the permissible personal data gathered) and predicted impacts 175 resulted from proposed changes or strategies. By tracking and/or categorizing impact data over time, users can see how their impact changes, how their impact is comparable to others in various categories, and how effective certain strategies have been at reducing impact, as well as how closely they have adhered to proposed strategies. Data can be fed into one or more analysis processes 201 that provide targeted and comprehensive impact insights.

FIG. 1B shows an illustrative example of database sets that can be compiled and used for impact analysis. The sets may not have a direct correlation to the various personal data categories, or they may, but they can provide very good background data usable to perform a “full cost” impact analysis in a reasonably accurate manner.

Once parameters are set for what factors will be considered, the data can be applied and apportioned to the full impact, or a relatively full impact, of a good or action. For example, driving to a store can include the impact of fuel usage, the impact of driving habits, the apportioned impact of additional passengers, etc. Purchasing goods at the store can include the production and transportation impact of those goods, as well as an apportioned share of the impact of driving to the store. Since the data is all being analyzed and controlled by a single source, there is less fear about double-counting data when considering an overall impact—i.e., instead of the driver being assigned a carbon output value for the trip and having the carbon cost of the trip also assigned to the goods purchased, a net total carbon value can just reflect that cost once. Individual category values (e.g., transportation vs. consumption) may have the cost assigned to each, for purposes of understanding the isolated impact of those activities, but the background analysis will know when data is being duplicatively used and can accommodate this when showing net totals and when making recommendations as to how to reduce impact.

When it comes to a vehicle, for example, there can be an impact cost of production and transportation of the vehicle, as well as a net lifetime cost. For example, a vehicle purchased and driven only a few miles will have a relatively high impact assigned to the life of the vehicle, if the impact is assigned per mile driven, for example, but will have a relatively low output impact, since little fuel will be used. As the vehicle is used more, the per-mile impact of the production and shipping of the vehicle diminishes per mile and the fuel usage begins to control that number, as well as having a greater effect on the overall impact of the vehicle.

For example, a gasoline powered vehicle may have a lower initial impact cost, but after fifty thousand miles may have a higher net impact cost, as opposed to an electric vehicle, which may have a higher initial impact cost, but a lower per-mile effect, leading to an aggregate value that is much lower over a certain number of miles driven. While one could argue that simply not driving the vehicle leaves the gasoline vehicle as a less impactful vehicle, the reality is that most people require a certain amount of transportation. Knowing the “break even” point for vehicles can allow consumers to decide, based on their own travel habits, which vehicle makes more environmental sense. That is, a person intending to travel only 20 miles a week for groceries, because they work from home, may have a less impact by purchasing a gasoline vehicle (if the breakeven point is, for example, thirty thousand miles). On the other hand, someone who commutes forty miles each way per day may be better served buying an electric vehicle, in terms of impact, as the mileage may approach thirty thousand fairly quickly. By educating users on the impact of their own personal behavior, as opposed to estimates that may or may not apply to their situation specifically, people can make much better choices that actually account for their own behavior, instead of assuming that their behavior will match that of a proposed estimated model, and making decisions on that basis.

The fuel section 110 of the database can include, for example, various fuel types 112, carbon outputs or costs of using those fuels 114, one or more known alternatives 116, comparative costs of the alternatives 116 to the primary source 112, in terms of both impact and actual cost. This data can be used to both estimate the impact of using a certain amount of a certain fuel in a vehicle, as well as alternative fuel usages, estimated actual costs or savings of switching fuel types, and the changes in impact resulting from fuel changes. So, for example, if both users in the commuter example above were initially using gasoline vehicles, the first user might be informed that switching to an electric vehicle would save a few dollars a week, and would output slightly less carbon per week, but relative to the higher cost of the vehicle and the production impact of the vehicle, the net benefit may be low or negative. Thus, such a strategy may not be recommended for that person, or prioritized as a way to significantly reduce impact. At the same time, the second person may realize both significant impact and cost savings by switching, providing both a financial and personal incentive to switch vehicle types. Because context is considered, a blanket statement such as “electric vehicles are better for the environment” need not be applied, which may actually be a falsity under certain circumstances, as suggested above. Thus, conclusions drawn based on personal data can help the right people make the correct decisions that are circumstantially relevant, and avoid application of broad principles.

Similarly, data on the impact of vehicles 120 may be stored, which can include, for example, model types 120, a fixed impact cost 124 (e.g., production and shipping), an average impact cost 126 observed or measured for the vehicle, an alternative, comparable vehicle with differing impact 128 and the cost in impact and/or money saved or spent by changing. Significant additional data and data sets, far beyond those shown, can also be included, and these are merely examples of what may be stored for referential values usable in analysis.

While many people want to aid in saving the environment, most people are not in a position to simply ignore the monetary cost of actions, and so having the monetary and impact costs associated with a change can assist in determining strategies that not only assist in diminishing impact, but which also make fiscal sense. Some strategies may benefit both bottom lines, and therefore may be high priority strategies, where both an environmental and a financial case can be made for a change. Because behavior can be observed and recorded for a person, it is possible to calculate the change over time and the savings over time, assuming behavioral trends continue. So, for example, strategies that have meaningful impact to a user's specific behavior can be used, while not simply focusing on the raw impact vs. cost. That is, while switching a brand of kitchen cleaner from a high chemical brand to an organic brand may have a high impact, and a low cost, the user may use two bottles of that cleaner per year, and may better focus their efforts elsewhere. At the same time, switching a brand of water to a company that uses recycled bottles may have a much lower impact at the same cost (meaning the impact per savings is low), but the person's family may go through 48 bottles of water a week, making the net effect of impact much more significant. This is the correct strategy for that person, but not for a person who cleans houses professionally, but who drinks little water. As people are unlikely to change every aspect of their behavior at once, it may be beneficial to focus on the impactful efforts that matter under their personal context, and the illustrative embodiments provide a way for this to occur in a useful and personally applicable manner.

Still another database may relate to home appliances 140 and other devices used on a regular basis that have a meaningful impact (or any impact). This data can include, for example, model names 142, fixed production and transportation impacts 144, impacts of using certain settings 146 (if applicable, otherwise, just a general usage impact), an alternate setting that achieves similar results 148 (if applicable), alternate brands, models or products that can be used 150, and cost data 152 for various comparisons between the brands, models and settings. Cost need not be a singular data set, but can be appended to each alternative as well as the core model and core settings, if applicable.

A further example dataset may relate to food 160, which can include types of food 162, fixed production or growth costs 164, alternative sources of either the same food, or food having similar nutritional value 166, 168, and costs associated therewith 170.

While it is possible to have many alternatives for any given action or item, food may have more alternatives than most, because it may be easy to discern that the “best” alternative SUV under $40,000 is Type X, and the cheapest alterative is Type Y, but for food it may be much more difficult to determine proxies and, for example, there may be fifteen types of oranges that come in both organic and non-organic varieties, let alone all food that gives comparable health benefits to eating an orange. The databases can have tens of thousands of entries, as those will aid in most accurately analyzing true net impact of an individual's actions.

Goods 180 may be yet another example category, with lists of items 182, fixed impacts 184, a projected life of a good 186, and average cost per life 188, alternatives 190 and costs 192. With regards to goods and other items have a certain life, but which may have limited to no impact during the life (e.g., a couch), it may be more useful to a person to contemplate the average impact per life of the good. That is, a couch that is projected to last for two years because of shoddy construction may have a much higher impact per life cycle than a couch that is projected to last for twenty years, even if the production impact of the shoddier couch is lower, because one would have to buy ten such couches over the lifecycle of the better-built couch.

Consumers have virtually no access to information and calculations such as the above, and having the comprehensive data analysis can help them make the best decisions based on impact without drawing false conclusions based on misrepresented data. Planned purchases could also be considered, so that consumers could reference the data and consider the impact prior to making a purchase, which may be important to people when buying goods that will be kept for a long period of time (making information about what they “could have bought instead” somewhat useless after the fact).

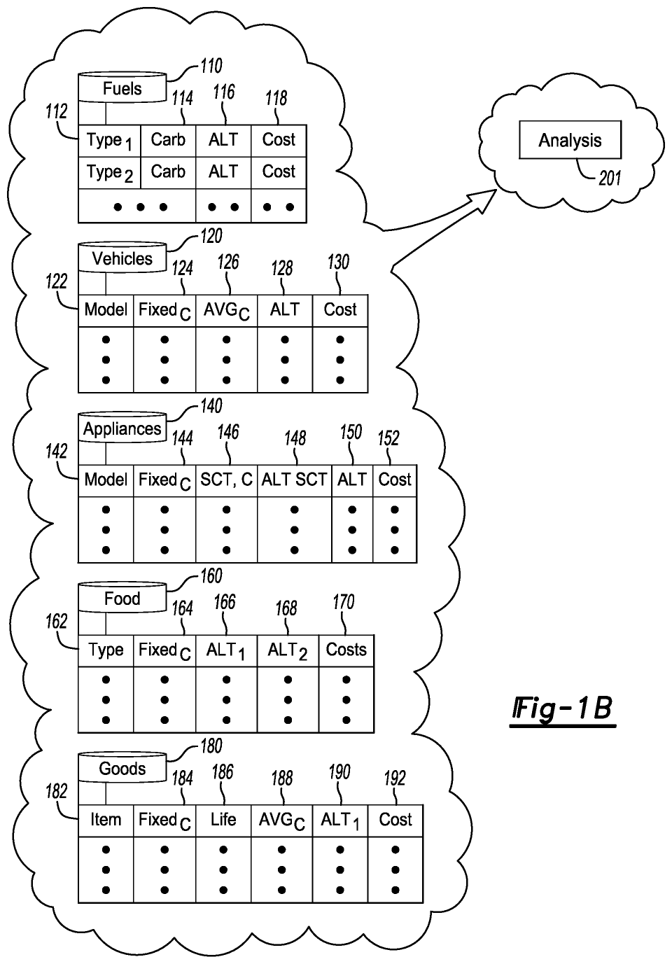

All of the databases may be accessible by the analysis engine 201, discussed in greater detail with respect to FIG. 2.

FIG. 2 shows an illustrative example of an analysis framework and outputs. Analysis processes 201 can draw information from personal data for a given user 203, data about others 205, such as those in a similar locality, demographic, exhibiting similar behavior, etc. Demographics may be aligned in a manner that is broadly or specifically relevant. Machine learning can aid in understanding the usefulness of a demographic metric, and observation may reveal, for example, that the type of shampoo people use is highly pertinent in categorizing their behavior generally, and the type and quantity of apples that people purchase is highly useful in categorizing their grocery shopping habits specifically. So, for general impact analysis, a demographic would be based on shampoo usage, and for grocery-based impact analysis, demographics could be based on apple-shopping habits. Having such a vast array of data about individuals allows for better and more useful categorizations and can lead to better comparisons and definitions of demographics that are situationally relevant, as opposed to simply relying on age, race, gender, locality, etc.

Data such as that in FIG. 1B represents costs and impact values 207 and can be used to quantify the impact of a person's behavior and habits, and strategies databases can be used to compare known useful strategies (those observed to have high incidences of compliance and/or very positive results) to the person's own behavior, to determine which strategies are best for that person. Strategies can also be crafted dynamically for a person based on the alternative data stored in the cost and impact values 207, as well as that person's behavior, but when certain strategies or types of strategies are observed to have broad compliance or significant effect in a wide population or within a demographic, those strategies can be detailed in the strategies data sets 209 to provide base models for suggestions to other users. Again, machine learning processes can cull and sort the strategies, as well as look for cohesion between various strategies to determine root causes or common denominators for success.

FIG. 2 also shows illustrative output data that is illustrative, but non-limiting, with regards to what may be shown to a user. For example, a user may be shown an aggregate footprint 211, which includes categorized footprint values, such as, but not limited to, travel 213, vehicles 215, shopping 217, etc. There may also be a graphic representation 219, such as a scale or graphic representing aggregate impact (relative to other categories), impact relative to other similar users, impact relative to national averages or regional averages, etc. Users may be able to tune values to show, on a group or individual basis, different comparatives. For example, a person who commutes forty miles a day may only want to be shown vehicle data relative to comparable commuters in a similar locality, whereas they may want their shopping habits compared to all others in a different demographic, and such settings could be controlled by the user or set by default.

A comparables output 221 may more accurately show the visible comparison for each category 223, wherein one or more comparable graphics 225 could be shown in conjunction with a personal graphic. So, for example, the commuter could see comparables to other similarly-traveling commuters, to a population in a locality, to a state or region population and a national or global comparison. Users may be able to select comparisons for use, and if there is sufficient data about others in the selected demographic, the data may display highly accurate information about the particular comparable data, allowing the user to make an accurate assessment about where they can most improve their own behavior.

A user dashboard or similar menu 230 may provide for a comprehensive look at carbon data. In this non-limiting example, the dashboard provides access to a variety of non-selectable or selectable options. Selection of a selectable option may drill down into another dashboard or display, so that, for example, selection of a profile option 231 may show the user's comprehensive impact data. Selection of a demographic option 233 may allow for broad or selective tuning of demographic comparisons, allowing a user to define against whom they would like to be compared, for what purposes. Observing people's decisions about demographic selections may also aid in baseline default demographic selection, so that, over time, the baseline selections accurately tend to reflect how people would eventually tune their demographic selections when given a choice.

Users may also be able to select categories 235 for display. Users may be provided with a dropdown or static list of selectable 237 categories 239, and selecting certain categories may affect displayed values, such as personal impact 241, demographic impact 243, and regional impact 245. For example, if a user thought that travel was their most-improvable source of impact, they could reduce the display to travel impact, seeing their travel impact personally 241, the impact of a demographic that was assigned or chosen for comparison 243, and the impact of a region 245, to quickly visually understand where they stood relative to the groups.

A selectable strategies item 247 could provide presently recommended strategies, as well as alternative strategies and strategy adherence and efficacy tracking. For example, one strategy could be “make fewer trips to the store and buy more X each time to reduce the need for travel.” Since the travel and shopping habits of that user may be stored in their personal vault, it may be possible to determine adherence to the strategy, as well as demonstrate the positive impact achieved by adherence (if adherence is observed). Users may discover that some strategies are impractical and can use the strategies selectable to swap out some strategies for others to which they are more likely to adhere.

For example, strategies 261 shows selectable strategies 263 with selection boxes 262. The strategy could include projected savings in impact 265, as well as a projected positive or negative monetary cost 267 (or time cost or savings, or other relevant cost or savings). The data could also show the impact of a more aggressive alternative 269 or a less aggressive alternative 271, and the user could decide which version of a strategy could be applied based on a cost/benefit analysis. Choices of definitions of cost (e.g., time vs. money) and definitions of benefit (e.g., money savings vs. impact savings) could be definable by a user and be used to sort and display the data in a manner that was personally meaningful.

The dashboard 230 may also show target reductions 251, graphically represented 255. This can be an overall target or one within one or more selected categories. A current impact display 253 may show the baseline and a current value (over a time period, for example), allowing for a visual analysis of where the user stands 257 relative to the target 255 and how much savings on impact has been achieved 259. Selection of different categories 235 could change what is shown in this targets tab, either for a given category or several categories grouped together, and allow each user to make the changes that best fit within their personal models and preferences and which best allowed them to mitigate impact accurately and within their tolerance for behavioral change.

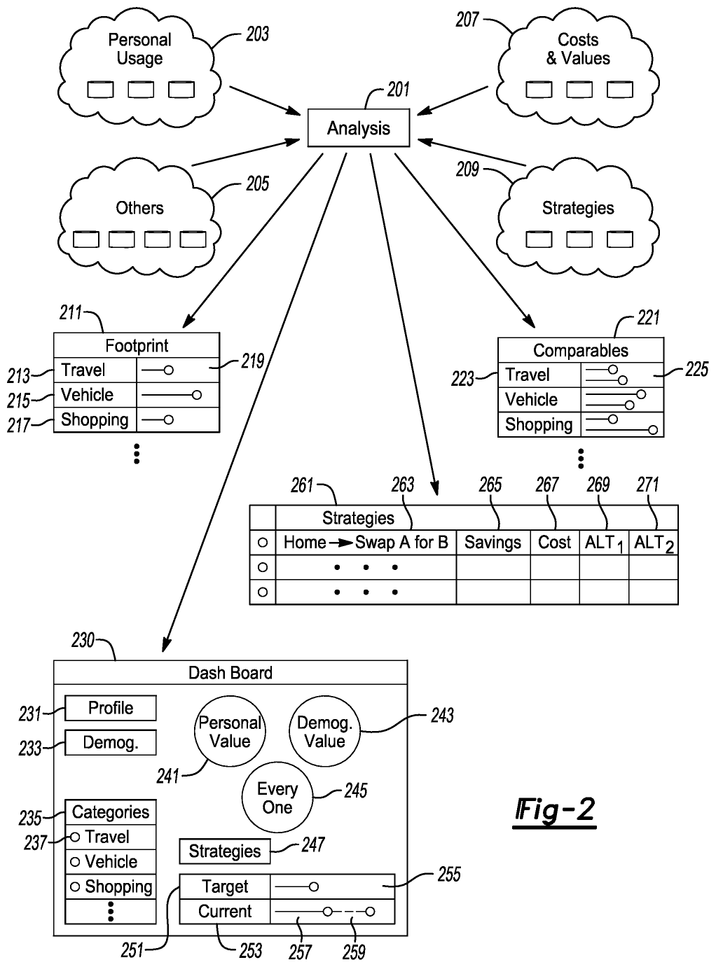

FIG. 3 shows an illustrative process for strategy application, automation and adherence tracking. In this example, a user may be presented a value representing current impact at 301 related to a good, category, behavior, etc., as well as a strategy to reduce the impact at 303. All pertinent data may be included, such as that shown in strategy display 261 by way of example. The user can be given a choice to accept and apply the strategy at 305, or discard the strategy in favor of another and/or to ignore a change to that particular impact at this time. If additional strategies remain, such as other strategies that fit within preferences or behavior parameters for that user at 307, the user can be presented with one or more alternative strategies.

What sorts of strategies a user is likely to enact can be observed and determined over time, and based on user preferences, observed behavior and strategies that people or a common demographic generally find acceptable. For example, it may be observed that a group which eats fast food thrice a week does not do well with strategies to avoid fast food, but is willing to swap source A for source B quite frequently, and so that group would be given strategies related to instances where source B had closer proximity (diminishing travel impact) or better practices (diminishing production impact), etc.

If a strategy has automatable aspects at 309, the user may be given a choice to automate certain aspects of the strategy at 311. For example, a choice to go to restaurant A or B may not be considered automatable, as the user may want to select their own food on a daily basis. But a choice to set a thermostat 2 degrees lower for 2 hours a day, or to use a different setting on a washing machine, may be an automatable aspect of a strategy (for a smart thermostat or washer) and the user may simply want to implement the strategy automatically, at least for a period of time until the personal impact can be determined.

The user can provide permissions to access or control the automatable aspects at 313, which can give a central control process the permissions to log into or access a smart device or other controllable device and change settings or schedules, or otherwise control usages. The user may also be shown a control plan at 315, to confirm the user accepts the proposed changes and understands what the aspects of automation mean under context. If the user provides correct permissions (for digital and control access, for example), and confirms the displayed plan (if necessary), then the user will accept the control and plan at 317 and an automated process, such as an application executing in the cloud or on a local smart-control hub with access to the various features to be controlled, can adjust the settings as appropriate at 325 and set monitoring at 327.

Monitoring, in this particular context, may include tracking certain aspects of behavior or usage in order to apply selective settings dynamically. For example, a smart washer may have a load detection setting and two wash settings (large load, small load). There may not be a configurable option to correlate load size to wash setting, so instead the monitoring process would take data from the load detection and, with permission, automatically set the wash setting. Even if a user always selected “large load,” this may be overridable by the monitoring and control process and the user could effectively have the correct load wash controlled, reducing impact, without having to take any overt steps. If the user eventually was unsatisfied with the cleanliness of clothing, the user could revert or tune the automatic control, or the user could enjoy the benefits of impact reduction without being materially impacted in any way with regards to their daily routines. Moreover, this allows users to take advantage of smart features of appliances that would otherwise go unused because of the complexity of understanding those features and their applicability, which provides added incentive for the manufacturers of those appliances to help aid in communication and compliance with the monitoring and control processes proposed.

If the user does not accept the plan at 317, the process may offer to adjust the plan in a general or user-specified manner at 319. If adjustment is requested at 319, any user modifications (e.g., things the user may want to change based on the proposed plan, such as setting a temperature to 70 instead of 69) may be input at 321 and the net impact effect of the new plan can be shown at 323, to ensure the user finds the impact savings acceptable. The new plan is also shown again at 315 and the process can repeat until a plan is accepted or no plan is selected.

Once any automatically controllable functions have been set, or when there are no controllable aspects, the process can begin tracking adherence to the plan at 329. This can include comparing observed and recorded behavior to the strategy recommended by the plan. For example, if the user buys milk twice a week in half gallons, the user may be recommended to buy two gallons of milk once every two weeks instead, to cut down on travel time and packaging usage. If the personal vault has permission to collect travel and shopping habits of the user, perhaps with aid of data received from a user rewards account with the grocery store, the process could track the purchases and frequency of milk and determine adherence to the new plan. If desired by the user, performance below a threshold at 331 could result in a gentle reminder to the user at 333. For example, the user could specify that if milk was bought in half gallons more three or more consecutive times, the user would want to be reminded of the plan. At that point, the user can switch behavior or decide the plan is too onerous and choose other impact reduction instead. The process can also update the improved impact data at 335, which helps the user track the reductions achieved through adherence to the new plan, which in the preceding case, should reduce packaging, travel trips for milk, and overall cost of both milk and fuel, among other things.

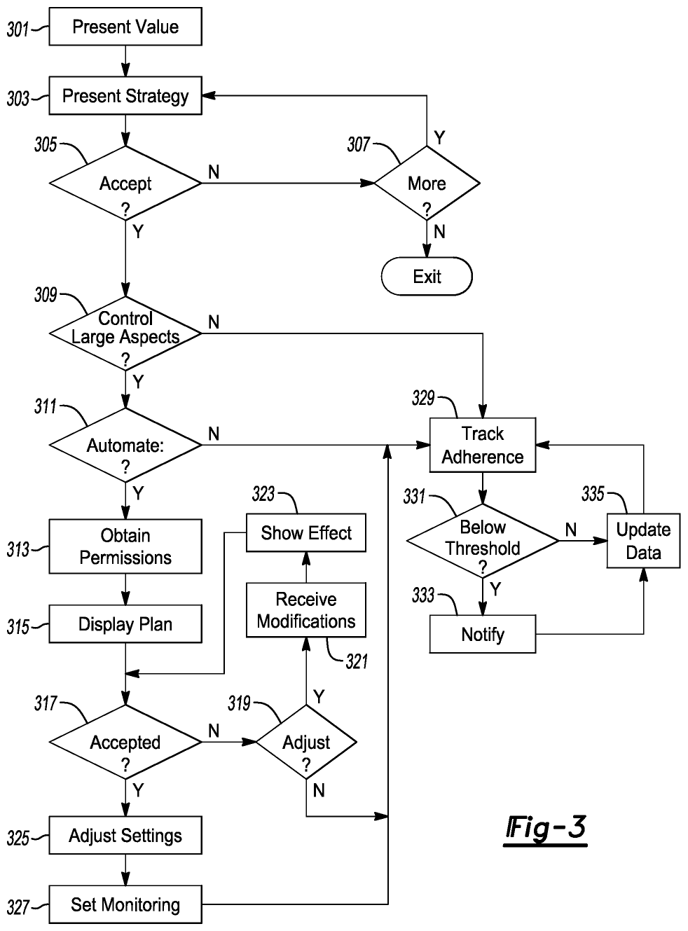

FIG. 4 shows an illustrative example of a tracking process in more detail. Because the proposed user vault is gathering data about many aspects of user life, with permission, the same information used to determine an impact can determine adherence or changes to impact upon future observation. This helps users avoid the necessity to specifically self-monitor all aspects of their life to make changes, and allows their own personal data vault to monitor the behavior instead, while preserving the data in a controlled and protected format so that it need not be used by anyone other than whomever the user chooses to allow it in the manners chosen to be allowed. Of course, the data may be gathered and used in the proposed monitoring manner in the absence of such a vault, but users may be more comfortable allowing such granular gathering and analysis in the presence of the personally controlled vault.

In this example, the process tracks progress over some time period a 401 (instance by instance, week by week, etc.). The time period may vary by activity. For example, a recommendation to drive less aggressively may be tracked for comparison each drive, but a recommendation to buy fewer potato chips in plastic bags may require weeks of tracking before meaningful comparisons can be made. Over the relevant time period, the process can compare the progress to the goals at 403, in terms of both compliance and projected effects. If the user wants to achieve N units of impact reduction, and is below that threshold, the user may not want to continue the changed behavior, or the user may want to work harder at changing the behavior. Similarly, if the user is well below a preferred compliance threshold, the user may want to work harder or cease attempting to comply.

If a threshold used for comparison (effect, cost, compliance, etc.) is not being met at 405, the process may notify the user at 407 and display relevant statistics at 409, which may include more than just the failed threshold. For example, the user may request notification below 50% compliance or a below a minimum goal of N units of impact per month. The user may only be 45% compliant, but may be shown that the goal is still being met. Based on their own observations about the impact on their life of the changes, the user may conclude they are sufficiently complying and elect to maintain the tracking and notification at 411, perhaps with new thresholds needed to at least preserve the minimum reduction of N units per month. If the user decides that the notifications are too frequent, or that the goal is unrealistic, or that they do not want to comply any more, for example, the process can clear the tracking goals at 413, revert any automated settings where applicable at 415 and cease any applicable monitoring and automatic control associated with the tracked target at 417. Alternatively, the user may be ok with the automated aspects and request cessation of the notification aspect of the tracking, but allow the automated settings to remain as specified.

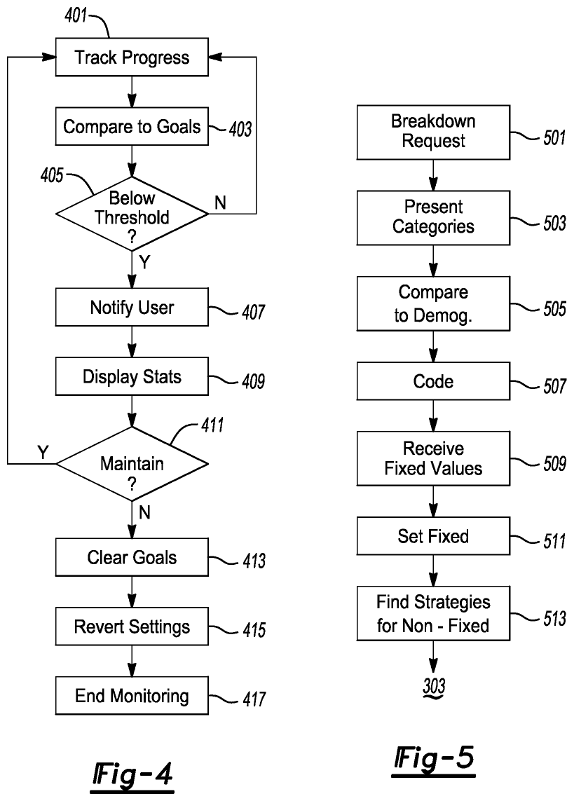

FIG. 5 shows an illustrative example for user tuning of demographics and goals for display and strategy selection. In this example, a user may want to, for example, implement a strategy for reducing travel impact relative to a group of peers. This request for a strategy may be broken down into components at 501, which are the components that may create some form of impact relative to a selected form of travel. For a personal vehicle, this could include, for example, idle time, choice of vehicles, travel times, travel times of day, routes, fuel choices, driving habits, etc.

The breakdown could be presented to the user as a group of categories at 503, which show an impact value for each aspect of the components that make up things that could possibly be modified. This could be compared to a demographic at 505, which allows the user to see their impact relative to the group in each category. For example, whether their vehicle has a greater per mile or base impact than the group, whether their driving behavior has a greater impact, whether their fuel choice has a greater impact, etc. The process may code each component with a relative ease of change or fixed nature as well. For example, in a vehicle instance, the fixed impact of a vehicle is not going to change unless the user changes vehicles, and moreover, the present fixed value is already a spent-cost, so changing vehicle types will not alleviate the prior fixed cost, it will add the new fixed cost of the new vehicle. As such, this may be coded a low priority aspect or one that, while it may result in a recommendation for a different vehicle when a user is shopping for a new vehicle, has little useful impact on a present strategy. The user may also specify certain fixed values, such as departure times or route choices, that the user is unwilling to change at 509. In the context of goods, a user may be willing to buy a different brand of something (e.g., cheese), but may not be willing to exchange cheese for another good.

The process sets all fixed values at 511 and then contemplates a strategy devised based on changing things the person is willing to change at 513. This can include focusing on the most-impactful non-fixed aspects, or the most cost-effective, etc. Additionally or alternatively, existing strategies can be searched to determine which strategies are most likely to have adherence. One or more strategies can then be presented to the user for consideration and application at 303.

For certain aspects of life, such as with regards to smart devices that have various energy control settings, strategies can include utilization of aspects of those devices for which the user is unaware. For example, a user could be told of a comparable smart device with a setting that would prove effective, or a setting on an already-owned device that would reduce impact. This incentivizes participation by device manufacturers, as well as inclusion of more effective efficiency settings if users want automated choices that will reduce their impact. Because the user can be informed of the effect of the impact, they may become more aware of the impact and care more about it, especially if it takes the form of a “set it and forget it” solution that involves no meaningful intentional change in personal behavior.

Strategies may also be accommodative of predicted context. For example, if a particularly cold few weeks were upcoming in an area, the strategy engine could accommodate this and either avoid recommending too low a temperature for a thermostat, or notify existing users with an automated setting that they may want to revert to a higher setting for that time period. These predictions could occur based on models of group or individual preferences, or based on observations that large segments of the group are disabling certain automated settings or choosing to avoid certain strategies with relevant aspects.

Similarly, in times of a shortage of certain goods, usage of alternatives may be more or less reasonable dependent on cost and availability, and the strategies could be ranked in any of the preceding instances based on those which are most likely to be followed.

Carbon or other environmental impact credits (water usage, etc.) can further be created, banked, stored and managed by a PDV or similar system. The user may have one or multiple wallets associated with the PDV that store credits accumulated by the user for various things. These can include, for example, real money credits, cryptocurrency credits, discounts, merchant credits and environmental impact credits. If the PDV can reasonably accurately store and track environmental impact, it may be able to assign usage values.

For example, while it may never become mandatory that individual people manage their impact credits, there may be a government or privately sponsored program or programs designed to encourage environmentally responsible behavior. Accordingly, people could accumulate credits for activities when they are below a defined usage threshold, and the PDV can calculate and track this information. Those credits could be used as a badge of honor, or even possibly be sold to other users or organizations who are mandatorily required to either accrue or create credits.

If the PDV has access to a large number of databases that accurately or reasonably accurately assign carbon or other impact value to activities, those resources could be used to calculate the value accruable or cost attributable to a change in behavior. This could include, but is not limited to, travel habits, home appliance usage habits, fuel usages, vehicle or other purchases, etc. For example, purchasing an electric vehicle may have a large fixed cost in environmental impact, but then the user would quickly “earn” that back in carbon or other credits. If those credits were exchangeable for value, the user could actually decrease the net cost of the vehicle by exchanging the credits.

Also, at present, manufacturers of such vehicles reap the value of those credits, but the value is potentially more realized in the usage of the vehicle, not the production, and so the credits should be attributable to the user who is saving energy, not the company that produced the vehicle capable of saving energy. A PDV system that could accurately track usage would allow for the credits to be placed in the proper hands and used as each user saw fit. Comparable calculations could be done for other efficient products—manufacturers may gain some portion of the credits, but users, who are the ones who have to make the decision to create the efficiency and actually exchange appliances and vehicles for less impactful ones, may deserve some value for the savings too. This would also encourage proper behavior, as well as give the users an incentive to sign up for a system that allowed for realization of the value created by their less impactful behavior.

Value can also be tied to localities and local behavior—installing a solar roof in California may create a lot more energy than installing one in northern Michigan. Users could see the real value in their personal locality, as well as the actual credits that might be accrued, and determine if the cost of such a roof, and any environmental overhead accrued in building such a roof, is worth the eventual offset. Since the PDV may be tracking real-time creation and usage of credits associated with other comparable structures in a proximate locality, the users can get reasonably accurate assessment of what local characteristics create meaningful impact—e.g., only placing such a roof on a south-facing facet of a roof in cloudier and more northern climes.

In some instances, users could actually turn their smart home appliances, and possibly even their vehicle, into carbon or impact credit “miners.” While the classic notion of a miner in the digital sense is creation of something, in this instance the creation would come through changing a habit to use less resources or create less impact.

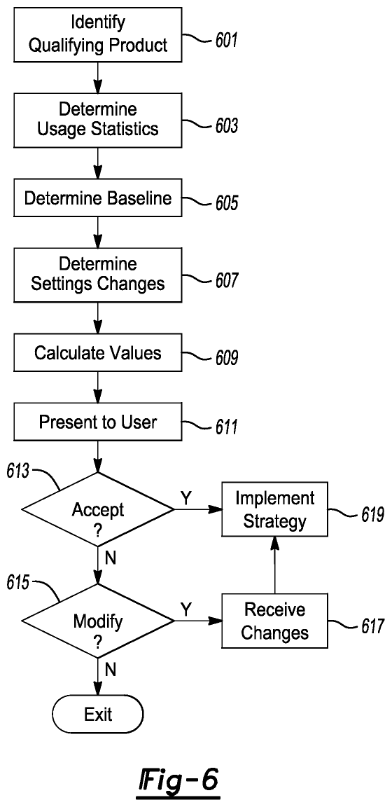

FIG. 6 shows an illustrative example of a process for impact credit mining using one or more home appliances. This strategy can be applied to any device for which usage could be tracked. For example, using a bicycle (determinable through GPS and speed associated with a mobile phone carried on the person), or even walking, can be used as an offset to vehicular travel. That is, if a user goes on a bike trip or walk with an end destination that replaces a destination which was commonly achieved using a vehicle, the user could be afforded credits for the journey, even if the bicycle was not “smart.” Again, because the person's PDV is wholly under their control and personal, collecting such detailed travel information may be something most people are willing to do, provided the data is not accessible by anyone else without express permission.

In this example, the process determines that the person owns a qualifying device at 601 or is engaging in a qualifying activity. As noted, the device may include something for which the usage could change (HVAC system, water heater, refrigerator, washer/dryer, vehicle, etc.). Even not owning a device could constitute a carbon mining opportunity, such as someone who bikes everywhere they go—those people, if willing to be tracked in travel, could be continually mining impact credits. Accordingly, it may be alternatively possible to determine list of the most impactful devices or classes of devices, and then assign mining values based on the lack of possession or use of alternatives to certain devices as well, assuming the alternative were trackable in some manner.

Shopping habits could also qualify as mining opportunities, such as purchasing food or goods that are less impactful than a target baseline. The baseline may be derived from an average of the most popular variants or average impactfulness of a set of commonly used versions or common approaches to an activity. The person's personal usage statistics, in this example, are calculated at 603 and the process also determines a baseline (or looks up a baseline, if one already exists) at 605.

The baseline may be varied by demographic, such as region or locality, as it may be reasonable to assume that someone in Michigan will use more heat in winter than someone in Arizona. Similarly, someone in Seattle may need less sprinkler usage than someone in Nevada. Whether region or another demographic is chosen, with sufficient PDV users, the process can determine an appropriate baseline for a device or activity that represents a theoretical desired usage, but which also accommodates reasonable expectations for usage (e.g., it may not be reasonable to tell someone to set a thermostat at 65 degrees when it is −10 degrees outside, unless their house is perfectly insulated).

Mining occurs when usage or activity is below the baseline. This can be the result of existing behavior, or may be the result of a change in behavior. In a system where the settings can be automatically controlled by a process, the process may determine settings changes at 607 (e.g., use a lower-water setting on a washer, run sprinklers for less time, use a shorter or lower-heat dryer setting, turn down a thermostat or water heater, etc.). Other determined changes may be replacement activities—e.g., recommending usage of a bicycle for short trips to a local convenience store.

The process can calculate the credits that would be accrued in the change in activity at 609, showing the user the net gain in credits through behavioral changes. Certain activities may already be above the reasonable baseline, and users may also be negatively mining credits in certain activities, and want the changes as an offset to another activity they cannot change, or want to move their credits to an overall net positive status. Since the PDV can potentially analyze a myriad of behaviors and devices, and build an overall profile, the process may also derive a net positive strategy with a mining target in mind (e.g., 0, or positive, or minimally negative). The user can identify the target (or a private or government organization may reward a target) and the user can be presented with an overall strategy that achieves the target.

If the user has set certain constraints on aspects of their life that cannot change, the overall strategy can accommodate this and create a strategy that is less impactful on the user (in terms of change) and less impactful on the environment in terms of environmental impact. The process can present the strategy to the user at 611 and if the user accepts the strategy at 613, the process can change any settings on devices at 619. With regards to behavioral changes, the process could send reminders or push reminders through an application on a mobile device, or, for example, push reminders when the user was engaging in behavior that fit a pattern of behavior that was supposed to change.

For example, if a user purchased beer from a local convenience store at or around 6 pm on Fridays, and the user had an intent to use a bicycle when practical, the user entering a vehicle at 5:50 pm on Friday could be assumed to be a trip to the store. Then, based on local weather patterns and temperature, on reasonable days the process could push a reminder to the user that, if such a trip were the intended reason for vehicle usage, maybe the user would want to use a bicycle instead. Users could control the pace and frequency of reminders so as not to be overly bothered.

If the user wants to modify the strategy at 615, the user can select from alternative approaches at 617, such as alternatives proposed by the process, or explicitly change a value or proposed setting. Additionally or alternatively, the user can exclude certain changes and change a profile to reject those changes in the future. Moreover, because the process may observe changes received from a wide variety of users, the process can become smarter in certain recommendations and avoid making suggestions that are commonly widely rejected.

Through the examples presented in and similar approaches and systems, users can benefit from personal data collection by using analysis of such data to reduce environmental impact. The achievable calculations and strategic determinations can be realized through large scale data analysis, and the solutions can be rendered much more likely to be accepted through use and presentation of complete information that is not only likely accurate, but also is likely accurate under context that is applicable to that specific user or instance. That is, instead of a statement that X device achieves Y savings, the processes, and the like, can more accurately determine the actual values of Y for a variety of context based on real observations of actual impact achieved by others under similar context. This can lead to widespread adoption of behavior and usage changes, as well as encourage participation in system that allow for tracking and calculation of such impact in a manner that is secure from a user perspective.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
collect ongoing user activity information relating to a predefined activity, using one or more devices having a predefined relationship to a user;
determine an environmental impact value of the predefined activity based on environmental impact caused by one or more aspects of the predefined activity;
determine at least one change to the predefined activity that would achieve a diminished environmental impact;
suggest the change to the user via a device interface; and
implement a control strategy to assist the user in achieving the change, responsive to acceptance of the change.

2. The system of claim 1, wherein the devices include a home appliance.

3. The system of claim 2, wherein the predefined activity includes usage of the home appliance.

4. The system of claim 1, wherein the devices include a mobile personal device.

5. The system of claim 1, wherein the predefined activity includes travel achieved while possessing the mobile personal device.

6. The system of claim 5, wherein the one or more processors are further configured to:
determine a mode of travel based on travel characteristic information collected from the mobile personal device; and
determine the environmental impact based at least in part on the mode of travel.

7. The system of claim 1, wherein the devices include a vehicle.

8. The system of claim 7, wherein the predefined activity includes travel using the vehicle.

9. The system of claim 1, wherein the impact includes at least a fixed impact associated with one or more devices involved in the predefined activity.

10. The system of claim 1, wherein the change is determined based at least in part on user-defined parameters exempting specified changes and the change accommodates to the parameters so as not to utilize an exempted change.

11. The system of claim 1, wherein the predefined activity includes at least a device with changeable settings, and the control strategy controls the device settings in accordance with the change as suggested to the user, to automatically change a functioning of the device to achieve the diminished environmental impact.

12. The system of claim 1, wherein the control strategy includes delivery of one or more reminders to a user based on engagement in the predefined activity, and wherein the one or more processors are further configured to:
determine, based on information collected from at least the mobile personal device, that the user is engaging in the predefined activity; and
deliver a reminder to the mobile personal device to change an aspect of the predefined activity in accordance with the at least one change, responsive to determining that the user is engaging in the predefined activity.

13. The system of claim 12, wherein the one or more processors are further configured to:
determine that the user is engaging in the predefined activity in a manner not in accordance with the at least one change, based on information collected from the at least one mobile personal device, and wherein the delivery of the reminder is further responsive to the determination that the user is engaging in the predefined activity in the manner not in accordance with the at least one change.

14. A system comprising:
one or more processors configured to:
determine that a user is engaging in a predefined activity based on information collected from at least one computing device;
determine a context demographic for the predefined activity, based on context having a predefined correlation to the predefined activity and values associated with the context gathered responsive to the determination that the user is engaging in the predefined activity;
determine a baseline environmental impact associated with the predefined activity, defining an average environmental impact for the predefined activity based at least in part on the values associated with the context;
determine an actual environmental impact of the predefined activity as achieved by the user; and
assign a positive or negative value of environmental impact credits to a user digital wallet, based on a difference between the actual environmental impact and the baseline environmental impact.

15. The system of claim 14, wherein the one or more processors are further configured to:
determine at least one aspect of the predefined activity that can be changed to improve the actual environmental impact and a recommended change to the at least one aspect to improve the actual environmental impact;
suggest the change via a device display; and
implement a control strategy to automatically achieve the change, responsive to user acceptance of the change.

16. The system of claim 15, wherein the predefined activity includes usage of a configurable home appliance and wherein the control strategy includes reconfiguration of the home appliance in accordance with the change.

17. The system of claim 15, wherein the predefined activity includes purchase of a good and wherein the one or more processors are configured to:
determine that the user intends to purchase the good based at least on placement of the good in a digital shopping cart; and
wherein the control strategy includes recommending an alternative good having a lower environmental impact associated therewith, the alternative good being identified by the change.

18. A method comprising:
determining an aggregate environmental impact of a plurality of user activities to form an environmental impact profile for the user, the aggregate environmental impact determined based on information gathered from one or more user devices and indicating user behavior related to the user activities that generate an environmental impact;
determining at least one change to at least one activity of the plurality of activities that would result in diminished environmental impact from that change;
presenting a impact reduction strategy including the at least one change to the user via a device display; and
implementing a control strategy to automatically enact the at least one change responsive to user acceptance of the impact reduction strategy.

19. The method of claim 18, wherein the activities include at least home appliance usage and wherein the control strategy includes automatic reconfiguration of a home appliance to change a usage characteristic in accordance with the at least one change.

20. The method of claim 18, wherein the impact reduction strategy includes the control strategy and at least one other strategy.
